(19) United States
(12) Patent Application Publication
(10) Pub. No.: US 2013/0330947 A1
(43) Pub. Date: Dec. 12, 2013

(54) HOMEPLUG WITH CHANGEABLE TOP CASE STRUCTURE

(71) Applicant: ASKEY COMPUTER CORP., NEW TAIPEI CITY (TW)

(72) Inventors: JING-YI PENG, NEW TAIPEI CITY (TW); SHIH-PO LO, NEW TAIPEI CITY (TW)

(73) Assignee: ASKEY COMPUTER CORP., NEW TAIPEI CITY (TW)

(21) Appl. No.: 13/672,903

(22) Filed: Nov. 9, 2012

(30) Foreign Application Priority Data
Jun. 7, 2012 (TW) 101120471

(51) Int. Cl. H01R 27/00

(52) U.S. Cl. CPC H01R 27/00
USPC 439/173

(57) ABSTRACT

A HomePlug with a changeable top case structure includes a casing and a socket assembly. The casing has a first coupling portion therein and has an opening. The socket assembly has a second coupling portion for coupling with the first coupling portion, such that the socket assembly corresponds in position to the opening and thereby is coupled to the casing from inside and exposed from the opening. The HomePlug with a changeable top case structure is effective in dispensing with redesign and the manufacturing of a casing in its entirety, cutting die and material costs, enhancing ease of product design, and increasing assembly universality.

### CROSS-REFERENCE TO RELATED APPLICATION

This non-provisional application claims priority under 35 U.S.C. §119(a) on Patent Application No(s).101120471 filed in Taiwan, R.O.C. on Jun. 7, 2012, the entire contents of which are hereby incorporated by reference.

### FIELD OF THE INVENTION

The present invention relates to HomePlugs, and more particularly, to a HomePlug with a changeable top case structure.

### BACKGROUND OF THE INVENTION

A conventional HomePlug capable of voltage transformation or functional expansion comprises: a hole or slot configured for insertion by a plug; and a case formed integrally as a unitary structure. For example, the conventional HomePlug capable of functional expansion applies Power Line Communication (PLC) for performing Internet surfing and data transmission, and works in conjunction with a data communication network built from an existing power line framework present in an indoor environment, such as a home, an office, a hospital. Hence, Unlike VDSL/ADSL, Power Line Communication (PLC) does not require constructing an additional circuit network for building a new communication network; instead, Power Line Communication (PLC) allows a user to install a HomePlug directly on an indoor alternating current (AC) electric outlet, such that an electronic device, such as a computer or a cell phone, can be electrically connected to the HomePlug for carrying out data transmission, and enables data communication between the devices thus connected, thereby providing a local area network-based communication framework and allowing the devices to share their accessible resources.

In general, a HomePlug comprises a casing and a circuit board received in the casing, wherein the circuit board has a plug and a socket. A socket assembly is disposed on the casing of a conventional HomePlug. Slots and/or holes which meet socket specifications set forth by various countries are disposed on the socket assembly and adapted to be inserted by plugs of corresponding specifications. The socket assembly and the casing of the conventional HomePlug are formed integrally as a unitary structure by means of a die, such that the socket assembly is fixed to the casing. Hence, from a manufacturer's perspective, mold opening and mass production have to be carried out anew to the casing having a new socket assembly in order to produce HomePlugs of different specifications, thereby resulting in an intricate lengthy design process, requiring much manpower, and incurring a high cost.

### SUMMARY OF THE INVENTION

It is an objective of the present invention to provide a HomePlug with a changeable top case structure so as to change a variety of casings and thereby reduce the required manpower and costs.

In order to achieve the above and other objectives, the present invention provides a HomePlug with a changeable top case structure. The HomePlug comprises: a casing having a first coupling portion therein and an opening; and a socket assembly having a second coupling portion coupled to the first coupling portion, thereby allowing the socket assembly to be corresponding in position to the opening, coupled to the casing from inside, and exposed from the opening.

As regards the HomePlug, the first coupling portion and the second coupling portion are a heat stake and a jointing hole, respectively, so as to be corresponding in position to and coupled to each other by heating and melting.

As regards the HomePlug, the first coupling portion and the second coupling portion are an engagement hook and an alignment hole, respectively, so as to be corresponding in position to and coupled to each other in a separable manner.

As regards the HomePlug, the socket assembly has slots and/or holes that meet requirements of European Standard sockets, British Standard sockets, German Standard sockets, Australian Standard sockets, or American Standard sockets.

As regards the HomePlug, the casing further comprises a plurality of heat dissipation vents.

As regards the HomePlug, the casing further comprises a first case and a second case corresponding in position to and coupled to the first case.

As regards the HomePlug, the first case and the second case are coupled together by means of ultrasonic melting fusion, engagement, snap-engagement, etc.

Accordingly, in an embodiment of the present invention, a HomePlug with a changeable top case structure assumes a variety of appearance by changing a variety of casings without redesigning the casings and constituent elements therein. Alternatively, in another embodiment of the present invention, a HomePlug is capable of changing socket assemblies of different specifications and the corresponding circuit designs and thereby applicable to various socket specifications without redesigning a casing in its entirety, so as to dispense with the manpower, dies, and material-related costs which might otherwise be required for manufacturing the casing anew, enhance ease of product design, and increase assembly universality.

### BRIEF DESCRIPTION OF THE DRAWINGS

Objectives, features, and advantages of the present invention are hereunder illustrated with specific embodiments in conjunction with the accompanying drawings, in which:

FIG. 1 is an exploded view of a socket assembly and a casing of a HomePlug according to an embodiment of the present invention;

FIG. 2 is a schematic view of the socket assembly coupled to the casing according to an embodiment of the present invention;

FIG. 3 is a partial schematic view of the socket assembly coupled to the casing in FIG. 2; and

FIG. 4 is a schematic view of the casing of HomePlug according to an embodiment of the present invention.

### DETAILED DESCRIPTION OF THE PREFERRED EMBODIMENTS

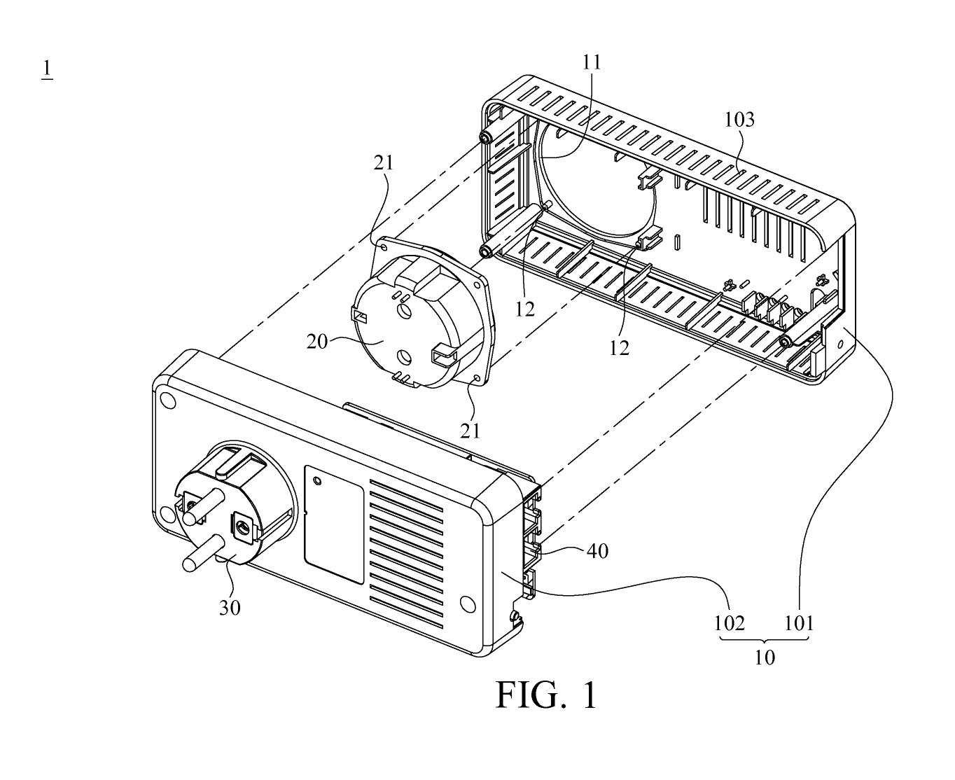

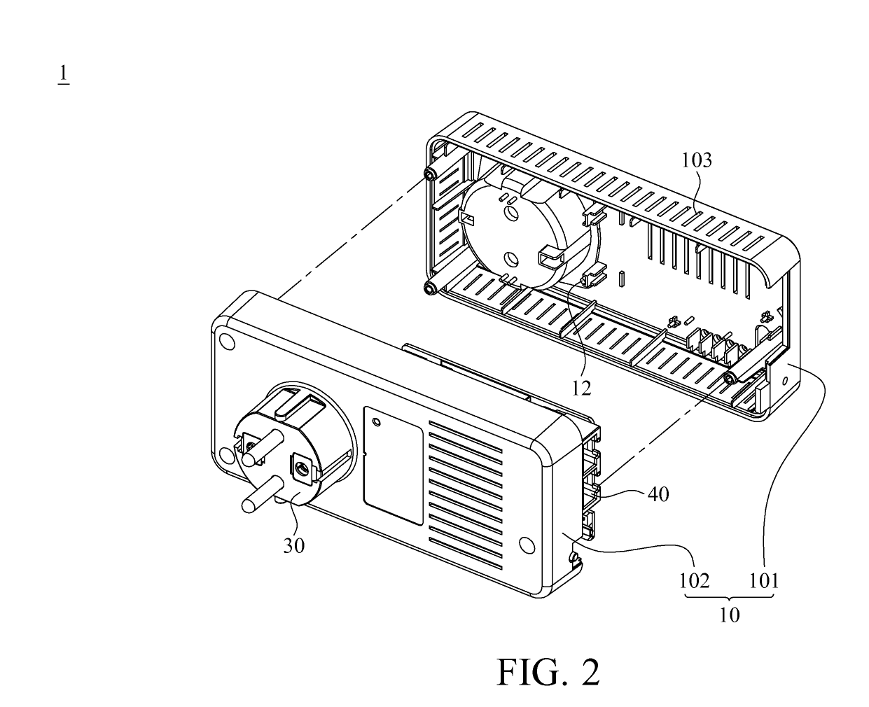

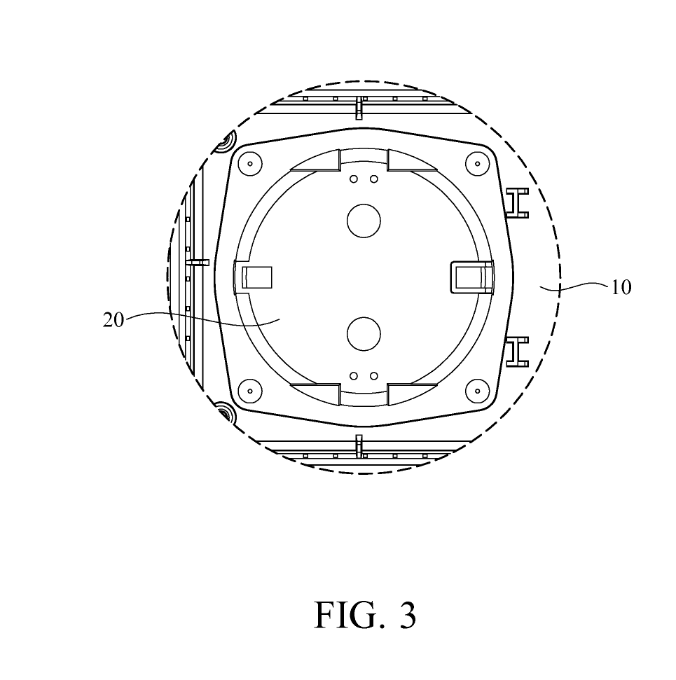

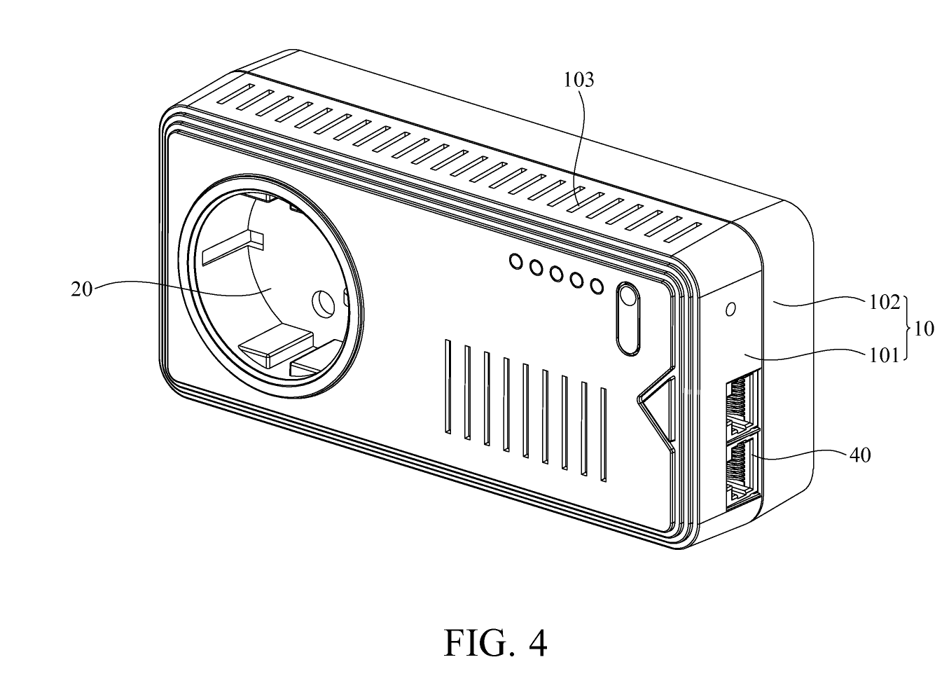

Referring to FIG. 1 through FIG. 4, there are shown diagrams of a HomePlug 1 with a changeable top case structure according to the present invention. FIG. 1 is an exploded view of a socket assembly and a casing of a HomePlug according to an embodiment of the present invention. FIG. 2 is a schematic view of the socket assembly coupled to the casing according to an embodiment of the present invention. FIG. 3 is a partial schematic view of the socket assembly coupled to the casing in FIG. 2 according to an embodiment of the present invention. Finally, FIG. 4 is a schematic view of the casing of HomePlug according to an embodiment of the present invention.

In an embodiment of the present invention, the HomePlug 1 with a changeable top case structure comprises a casing 10 and a socket assembly 20. The casing 10 has a first coupling portion 12 therein and an opening 11. The socket assembly 20 has a second coupling portion 21 coupled to the first coupling portion 12, thereby allowing the socket assembly 20 to be corresponding in position to the opening 11, coupled to the casing 10 from inside, and exposed from the opening 11.

In this embodiment, the first coupling portion 12 and the second coupling portion 21 are a heat stake and a jointing hole, respectively, so as to be corresponding in position to and coupled to each other by heating and melting. Referring to FIG. 3, the first coupling portion 12 is penetratingly disposed in the second coupling portion 21 to allow the first coupling portion 12 and the second coupling portion 21 to be melted and jointed, such that the socket assembly 20 is fixed to the inner surface of the casing 10 and exposed from the opening 11.

This embodiment and the accompanying drawings are illustrative rather than restrictive of the way of coupling the first coupling portion 12 and the second coupling portion 21 together. For example, the first coupling portion is an engagement hook disposed on the inner surface of the casing 10, whereas the second coupling portion is an alignment hole disposed at the socket assembly 20 and coupled to the engagement hook. Hence, the first coupling portion 12 is penetratingly disposed in and snap-engaged with the second coupling portion 21, thereby allowing the socket assembly 20 to be corresponding in position to the opening 11, coupled to the casing 10 from inside, and exposed from the opening 11.

In another illustrative embodiment, the first coupling portion 12 and the second coupling portion 21 are threaded screw holes penetrated by and meshed with screws, such that the casing 10 and the socket assembly 20 are coupled together. Preferably, instead of penetrating the casing 10, the first coupling portion 12 is formed in the casing 10 without penetrating the casing 10; in other words, the first coupling portion 12 opens on one of the two opposing sides of the casing 10 only, that is, preferably on the inner side of the casing 10 only. In the aforesaid preferred embodiment, for example, the depth of the first coupling portion 12 equals a half of the thickness of the casing 10. Hence, the screws and the first coupling portion 12 are invisible from outside the casing 10.

In this embodiment, the casing 10 further comprises a first case 101 and a second case 102 corresponding in position to and coupled to the first case 101. The first case 101 and the second case 102 are coupled together by means of ultrasonic melting fusion. Specifically speaking, the edge of the first case 101 is aligned with the edge of the second case 102 such that the first and second cases 101, 102 are fitted to each other to form a receiving space (not shown) therebetween, and then the first case 101 and the second case 102 are coupled together by means of ultrasonic melting fusion. Alternatively, engagement structures (such as a flange, an engagement sheet, or an engagement post) which match each other are formed at the edge of the first case 101 and the edge of the second case 102, respectively, such that the first case 101 and the second case 102 can be coupled together by the engagement structures. Furthermore, snap-engagement structures (such as stepwise edges) which match each other are formed at the edge of the first case 101 and the edge of the second case 102, respectively, such that the first case 101 and the second case 102 can be coupled together by the snap-engagement structures. Furthermore, the casing 10 further comprises a plurality of heat dissipation vents 103. Although the heat dissipation vents 103 are disposed on the lateral sides and the top side of the first case 101 as shown in the diagram, the present invention is not limited thereto. In a variant embodiment, the heat dissipation vents 103 can be disposed at any portion of the casing 10, provided that heat generated from a circuit board (not shown) disposed in the casing 10 and the circuit-related components is dissipated efficiently.

In an exemplary embodiment of the present invention, the socket assembly 20 has holes which match two round pins typical of a European Standard socket, but the socket assembly 20 of the present invention is not limited thereto. In practice, the slots and/or holes of the socket assembly 20 of the present invention can also match three round pins typical of a British Standard socket, two non-parallel flat blades typical of an Australian Standard socket, two flat blades typical of an American Standard socket, or two flat blades and a round pin (i.e., the grounding pin) of a socket.

As mentioned earlier, in an embodiment of the present invention, the HomePlug 1 further comprises the circuit board (not shown) disposed inside the receiving space in the casing 10. A circuit (not shown) is disposed on the circuit board and adapted to electrically connect the socket assembly 20, a plug assembly 30, and a network port 40, thereby providing functional expansion by means of Power Line Communication (PLC) or Power Line Networking (PLN). In practice, a user plugs the HomePlug 1 into an indoor alternating current (AC) electric outlet, connects an external electronic device (such as a personal computer, a notebook computer, a tablet computer, or a smartphone) serving a communication purpose to the network port 40 via a network transmission cable, and thereby enables data transmission to take place by means of the HomePlug 1 and a Power Line Network (PLN). Alternatively, the circuit board comprises the socket assembly 20, the plug assembly 30, and a wireless communication module element, such that the user plugs the HomePlug 1 into an indoor alternating current (AC) electric outlet, connects an external electronic device (such as a personal computer, a notebook computer, a tablet computer, or a smartphone) capable of communication to the HomePlug 1 by wireless transmission, and thereby enables data transmission to take place by means of the HomePlug 1 and a Power Line Network (PLN). In this embodiment of the present invention, the pins of the plug assembly 30 are exemplified by two round pins typical of a European Standard plug, but the plug assembly 30 of the present invention is not limited thereto; instead, the slots and/or holes of the plug assembly 30 can be three round pins as set forth by British Standards, two non-parallel flat blades as set forth by Australian Standards, two flat blades as set forth by American Standards, or two flat blades plus a round pin (i.e., the grounding pin).

Accordingly, in an embodiment of the present invention, a HomePlug with a changeable top case structure assumes a variety of appearance by changing a variety of casings without redesigning the casings and constituent elements therein. Alternatively, in another embodiment of the present invention, a HomePlug is capable of changing socket assemblies of different specifications and the corresponding circuit designs and thereby applicable to various socket specifications without redesigning a casing in its entirety, so as to dispense with the manpower, dies, and material-related costs which might otherwise be required for manufacturing the casing anew, enhance ease of product design, and increase assembly universality.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A HomePlug with a changeable top case structure, the HomePlug comprising:
a casing having a first coupling portion therein and an opening; and
a socket assembly having a second coupling portion coupled to the first coupling portion, thereby allowing the socket assembly to be corresponding in position to the opening, coupled to the casing from inside, and exposed from the opening.

2. The HomePlug of claim 1, wherein the first coupling portion and the second coupling portion are a heat stake and a jointing hole, respectively, so as to be corresponding in position to and coupled to each other by heating and melting.

3. The HomePlug of claim 1, wherein the first coupling portion and the second coupling portion are an engagement hook and an alignment hole, respectively, so as to be corresponding in position to and coupled to each other in a separable manner.

4. The HomePlug of claim 1, wherein the first coupling portion and the second coupling portion have screw holes and thereby are coupled together by screws.

5. The HomePlug of claim 1, wherein the socket assembly meets requirements of European Standard sockets, British Standard sockets, German Standard sockets, Australian Standard sockets, or American Standard sockets.

6. The HomePlug of claim 1, wherein the casing further comprises a plurality of heat dissipation vents.

7. The HomePlug of claim 1, wherein the casing further comprises a first case and a second case corresponding in position to and coupled to the first case.

8. The HomePlug of claim 7, wherein the first case and the second case are coupled together by one of ultrasonic melting fusion, engagement, and snap-engagement.
